(19) United States
(12) Patent Application Publication
(10) Pub. No.: US 2010/0181123 A1
(43) Pub. Date: Jul. 22, 2010

(54) Utilizing Propulsion of an Integrated Wheeled Vehicle

(76) Inventors: Jacob Maor, Ganey Tikva (IL); Ivgeny Budansky, Holon (IL)

Correspondence Address: The Law Office of Michael E. Kondoudis, 888 16th Street, N.W., Suite 800, Washington, DC, 20006, US

(21) Appl. No.: 12/357,515

(22) Filed: Jan. 22, 2009

(51) Int. Cl. B60K 25/08; B63H 21/175; B62D 63/00

(52) U.S. Cl. 180/53.61; 440/11; 280/414.1

(57) ABSTRACT

A device for transmitting the propelling force of a wheeled vehicle integrated within a vehicle to propulsion means of the vehicle. The device comprises a frame arranged to support the wheeled vehicle and to enable the integration of the wheeled vehicle within the vehicle; rolling elements operatively in contact with the wheels of the wheeled vehicle and arranged to rotate due to friction with the wheels of the wheeled vehicle; and a mechanical transmitter arranged to deliver rotational forces from the rolling elements to the propulsion means of the vehicle.

### BACKGROUND

1. Technical Field

The present invention relates to the field of transportation, and more particularly, to conversion of propulsion forces.

2. Background of the Related Art

There is a need of transforming propulsion from one for to the other, especially when using vehicles operation in different mediums.

### BRIEF SUMMARY

In a vehicle comprising a wheeled vehicle and propulsion means, embodiments of the present invention provide a device for transmitting the propelling force of the wheeled vehicle to the propulsion means. The device comprises a frame arranged to support the wheeled vehicle and to enable the integration of the wheeled vehicle within the vehicle; at least one rolling element operatively in contact with the wheels of the wheeled vehicle and arranged to rotate due to friction with the wheels of the wheeled vehicle; and a mechanical transmitter arranged to deliver rotational forces from the at least one rolling element to the propulsion means of the vehicle.

According to another embodiment there is provided a vehicle propelled by a propelling force of a wheeled vehicle integrated within the vehicle. The vehicle including: propulsion means; a frame arranged to support the wheeled vehicle and to enable the integration of the wheeled vehicle within the vehicle; at least one rolling element operatively in contact with the wheels of the wheeled vehicle and arranged to rotate due to friction with the wheels of the wheeled vehicle; and a mechanical transmitter arranged to deliver rotational forces from the at least one rolling element to the propulsion means of the vehicle.

According to still another embodiment there is provided a marine vehicle propelled by a propelling force of a wheeled vehicle integrated within the marine vehicle. The marine vehicle includes: a boat arranged to support the wheeled vehicle; at least one propeller arranged to operationally propel the boat; at least one rolling element connected to the boat and arranged to support at least one wheel of the wheeled vehicle, a mechanical transmitter comprising at least one belt, a first shaft, a gear box, a second shaft, differentials and an axle. The at least one rolling element operationally utilizes high frictional forces with the at least one wheel to receive the rotation of the at least one wheel. The first shaft is connected via the at least one belt to the at least one rolling element such as to transmit rotation of the at least one rolling to the first shaft. The gear box is connected to the second shaft and arranged to transmit rotation of the first shaft to the second shaft according to a predefined gear position. The differentials are connected to the second shaft and arranged to transmit rotation of the second shaft to the axle. The axle is connected to the at least one propeller and arranged to transmit rotation to the at least one propeller.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is an illustration of rolling elements operatively in contact with a wheel of a wheeled vehicle, according to some embodiments of the invention;

FIGS. 2A and 2B are illustrations of a vehicle propelled by the propelling force of a wheeled vehicle integrated within the vehicle, according to some embodiments of the invention;

FIGS. 3A, 3B and 3C are illustrations of a marine vehicle propelled by the propelling force of a wheeled vehicle integrated within marine vehicle, according to some embodiments of the invention;

FIG. 4 is an illustration of a marine vehicle propelled by the propelling force of a wheeled vehicle integrated within marine vehicle, according to some embodiments of the invention; and

FIG. 5 is an illustration of a vehicle propelled by the propelling force of a wheeled vehicle integrated within vehicle, according to some embodiments of the invention.

The drawings together with the following detailed description make apparent to those skilled in the art how the invention may be embodied in practice.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the present invention provide a towable vehicle, allowing a wheeled vehicle to overcome fluid (e.g., water) or sand barriers by temporarily integrating the wheeled vehicle in the towable vehicle and utilizing the propulsion of the wheeled vehicle to propel the towable vehicle, thereby avoiding the need for an additional propulsion means or supporting the current propulsion means with additional propulsion power. The towable vehicle thus comprises a frame, wheels allowing the towable vehicle to be towed, propulsion means and coupling means for utilizing the propulsion of the wheeled vehicle to propel the towable vehicle.

The towable vehicle further comprises floating means for overcoming a fluid barrier while the wheeled vehicle is integrated within the towable vehicle.

Operatively, upon facing a fluid barrier such as a lake or a river, the driver of the wheeled vehicle may separate the towable vehicle from the wheeled vehicle, prepare the towable vehicle to function as a marine vehicle and integrate the wheeled vehicle within it (e.g., by driving the wheeled vehicle onto the towable vehicle and establishing the interface of the two vehicles). Then, driving the wheeled vehicle, the marine vehicle is propelled over the fluid barrier. The marine vehicle may resemble a catamaran in an operational state. The marine vehicle (being the towable vehicle in operation mode) may be equipped with propellers that operate by the turning of the wheels of the wheeled vehicle. The propellers may have two axes of rotation, one for moving the marine vehicle forward and another for breaking and directing the marine vehicle.

Thus, the marine vehicle may be operated single handedly and be returned to a towable state after the fluid barrier has been overcome.

Upon facing a sand barrier, the driver of the wheeled vehicle may separate the towable vehicle from the wheeled vehicle, prepare the towable vehicle and integrate the wheeled vehicle within it (e.g., by driving the wheeled vehicle onto the towable vehicle and establishing the interface of the two vehicles). Then, driving the wheeled vehicle, the vehicle is propelled over the sand barrier. The vehicle may resemble a caterpillar vehicle in an operational state. The vehicle (being the towable vehicle in operation mode) may be equipped with any tracks that operate by the turning of the wheels of the wheeled vehicle. The vehicle may be operated single handedly and be returned to a towable state after the sand barrier has been overcome.

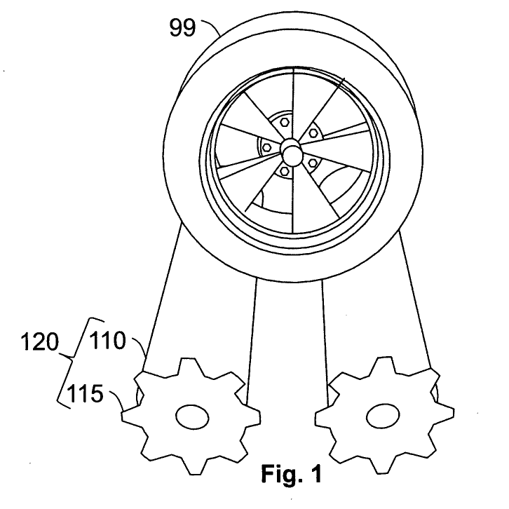

FIG. 1 is an illustration of rolling elements 120 operatively in contact with a wheel 99 of a wheeled vehicle, according to some embodiments of the invention. Rolling elements 120 comprise a surface 110 characterized by a high friction coefficient in respect to wheel 99. Rolling elements 120 are arranged such that surface 110 is moved upon rotation of wheel 99, e.g., surface 110 is allowed to roll around a cylinder, move pulleys, an the like. Rolling elements 120 further comprise components 115 arranged to operatively transmit the movement of rolling elements 120 further, such as gears, pulleys, etc. Wheel 99, connected to a wheeled vehicle, applies pressure to rolling elements 120. Upon turning, wheel 99 rotates rolling elements 120, which are arranged to transmit their rotation to a mechanical transmitter (see below), arranged to eventually transmit the rotation to propelling means (see below).

According to some embodiments of the invention, rolling elements 120 may be arranged to be moved by a single wheel 99, by two wheels or by more wheels 99. Rolling elements 120 may be arranged to be movable upon moving the axis of wheels 99, e.g., rolling elements 120 may be mounted on a bearing that may rotate rolling elements 120 with wheels 99.

According to some embodiments of the invention, rolling elements 120 may be part of a device for transmitting the propelling force of a wheeled vehicle to propulsion means of vehicle, wherein the vehicle comprises the wheeled vehicle and propulsion means. The device may further comprise a frame arranged to support the wheeled vehicle and to enable the integration of the wheeled vehicle within the vehicle and a mechanical transmitter arranged to deliver rotational forces from the at least one rolling element to the propulsion means of the vehicle. The device may enable avoiding the need for an additional propulsion means or may be used to support existing propulsion means with additional propulsion power.

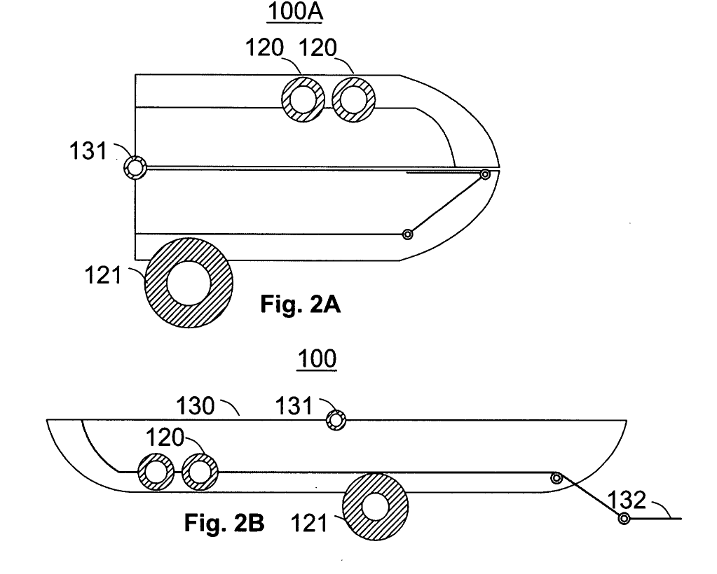

FIGS. 2A and 2B are illustrations of a vehicle 100 propelled by the propelling force of a wheeled vehicle integrated within the vehicle, according to some embodiments of the invention. Vehicle 100 is shown in an operating mode and in a folded, towed mode 100A. Vehicle 100 comprises a frame 130 arranged to support the wheeled vehicle and to enable the integration of the wheeled vehicle within vehicle 100. Frame 130 may comprise a ramp 132 for loading the wheeled vehicle upon vehicle 100. At least one rolling element 120 is placed such that it contacts the wheels of the wheeled vehicle and rotates due to friction with the wheels of the wheeled vehicle. In this manner, a driver of the wheeled vehicle accelerates the wheels of the wheeled vehicle, and the wheels in turn rotate rolling elements 120.

Vehicle 100 may further comprise propulsion means (not shown in FIG. 2) such as wheels, propellers and the like. Rolling elements 120 are further connected to a mechanical transmitter (not shown in FIG. 2) arranged to deliver rotational forces from rolling elements 120 to the propulsion means of vehicle 100.

Vehicle 100 may comprise wheels 121 for enabling towing by the wheeled vehicle. Vehicle 100 may further comprise a vehicle connector (not shown in FIG. 2), such that vehicle 100 may be towed by another vehicle, or by the wheeled vehicle itself. Vehicle 100 may be arrange to be foldable, e.g., via an axle 131.

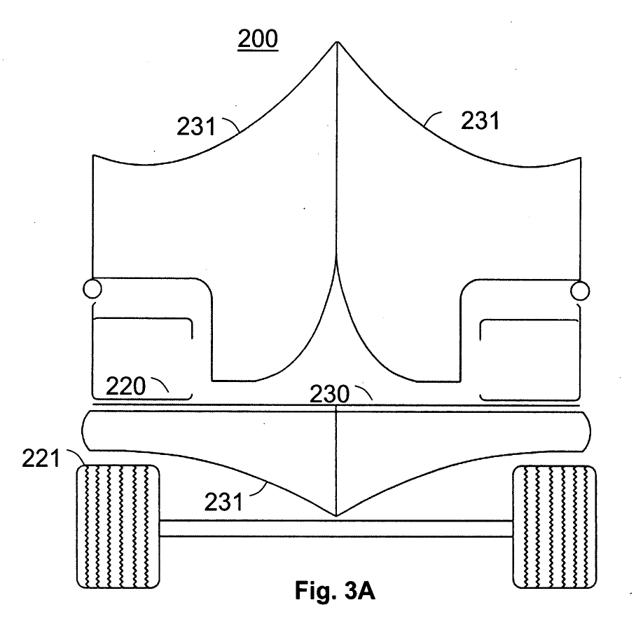

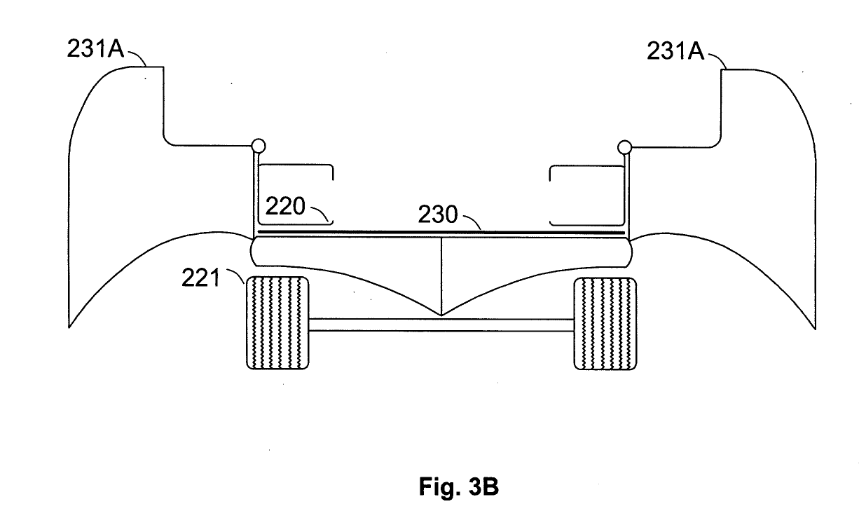

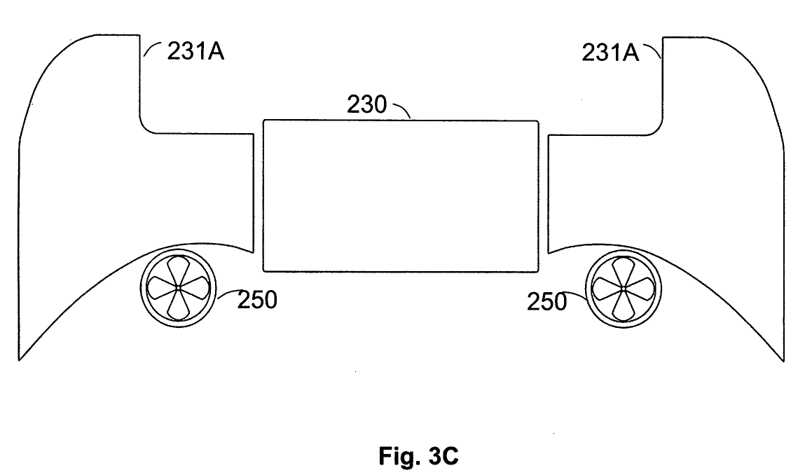

FIGS. 3A, 3B and 3C are illustrations of a marine vehicle 200 propelled by the propelling force of a wheeled vehicle integrated within marine vehicle 200, according to some embodiments of the invention. Marine vehicle 200 is presented in a folded, towable mode in FIG. 3A and in operation mode (without the wheeled vehicle) in FIG. 3B. Marine vehicle 200 comprises a frame 230 arranged to support the wheeled vehicle and to enable the integration of the wheeled vehicle within marine vehicle 200. Frame 230 may comprise a base for supporting the wheeled vehicle with at least one rolling element 220 that is placed such that to contact the wheels of the wheeled vehicle. Rolling element 220 may be arranged to rotate due to friction with the wheels of the wheeled vehicle. In this manner, a driver of the wheeled vehicle accelerates the wheels of the wheeled vehicle, and the wheels in turn rotate the rolling elements 220. Frame 130 may comprise wheels 221 for enabling towing of marine vehicle 200.

Frame 230 may further support floaters 231, for example on the sides of marine vehicle 200, on the bottom of marine vehicle 200 or on the top of marine vehicle 200. Floaters 231 may be foldable as presented in FIG. 3A (folded) and FIG. 3B (unfolded). Floaters 231 may be arranged to float marine vehicle 200 with the integrated wheeled vehicle upon fluids such as water, and insure an operationally effective floating in respect to the motion of marine vehicle 200 in the fluid.

FIG. 3C illustrates propulsion means 250 included in marine vehicle 200 that are arranged to move marine vehicle 200 through fluids, e.g., propellers. Rolling elements 220 are further connected to a mechanical transmitter (not shown in FIG. 3C) that is arranged to deliver rotational forces from rolling elements 220 to propulsion means 250 of marine vehicle 200.

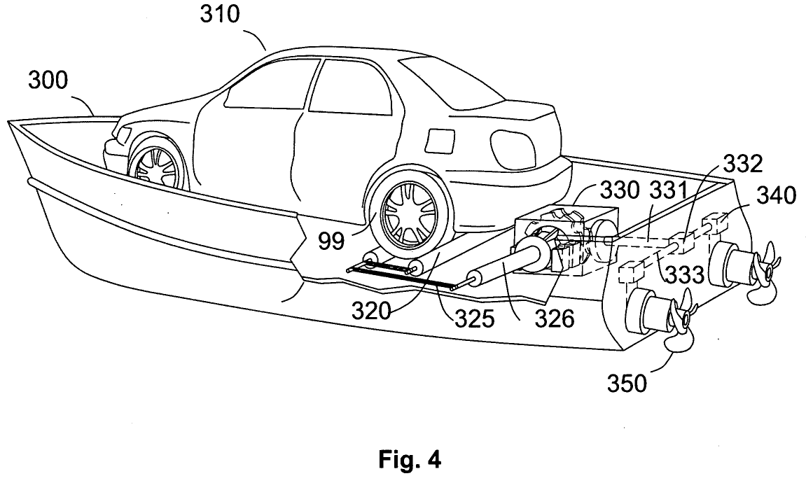

FIG. 4 is an illustration of a marine vehicle 300 propelled by the propelling force of a wheeled vehicle 310 integrated within marine vehicle 300, according to some embodiments of the invention. In FIG. 4, marine vehicle 300 comprises a boat and wheeled vehicle 310 comprises a car. Marine vehicle 300 further comprises rolling elements 320, arranged to support wheeled vehicle 310 and transmit the rotation of wheels 99 of wheeled vehicle 310 to the propelling means marine vehicle 300. Rolling elements 320 utilize high frictional forces with wheels 99 to receive their rotation.

Marine vehicle 300 further comprises propulsion means 350, in FIG. 4 propulsion means 350 are exemplified by propellers. Propulsion means 350 are connected to rolling elements 320 by a mechanical transmitter comprising belts 325, a first shaft 326, gear box 330, a second shaft 331, differentials 332 and an axle 333, arranged to deliver the rotational forces from rolling elements 320 to propulsion means 350 of marine vehicle 300.

Marine vehicle 300 may further comprise a docking system, allowing a connection of several marine vehicles or a connection of marine vehicle 300 to another marine vehicle, such as a yacht. Marine vehicle 300 may be connected serially to other vehicles.

Marine vehicle 300 may comprise a motor less version of a yacht, arranged to be both towable by wheeled vehicle 310 and propelled by wheeled vehicle 310 in an integrated state, utilizing the propulsion forces of wheeled vehicle 310. Operatively, marine vehicle 300 allows a user to move both on land an in the fluid with a single motored vehicle.

According to some embodiments of the invention, rolling elements 320 may be arranged to be moved by a single wheel 99, by two wheels or by more wheels 99. Rolling elements 120 may be coupled with either front or rear wheels, relating to the type of drive (front-wheel drive or rear-wheel drive) of wheeled vehicle 310. Rolling elements 320 may be arranged to be movable upon moving the axis of wheels 99, e.g., rolling elements 320 may be mounted on a bearing that may rotate rolling elements 320 with wheels 99. As a result, directing marine vehicle 300 may be carried out by directing wheeled vehicle 310 and transmitting the direction commands via wheels 99 and rolling elements 320 to marine vehicle 300, e.g., to propulsion means 350.

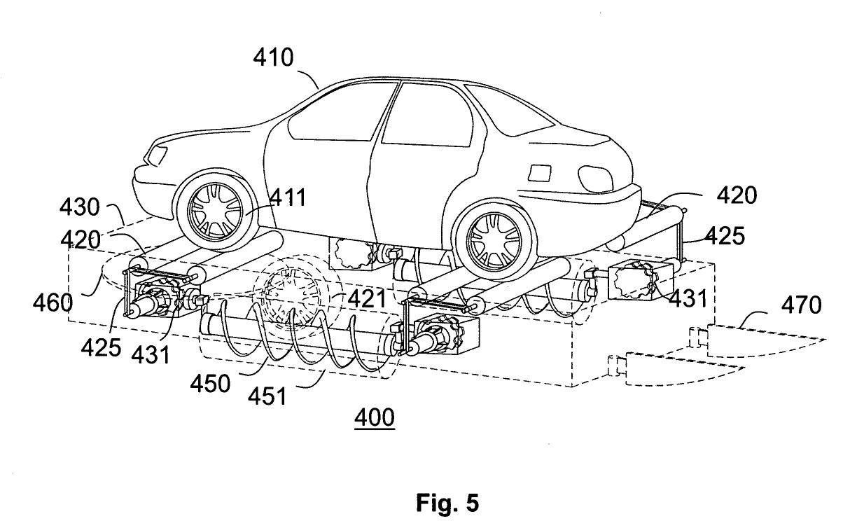

FIG. 5 is an illustration of a vehicle 400 propelled by the propelling force of a wheeled vehicle 410 integrated within vehicle 400, according to some embodiments of the invention. Vehicle 400 is shown from above, from the side and from the back. Vehicle 400 comprises a frame 430 arranged to support wheeled vehicle 410 and to enable the integration of wheeled vehicle 410 within vehicle 400. Frame 430 may comprise a ramp for loading wheeled vehicle 410 upon vehicle 400. At least one rolling element 420 is placed such that it contacts wheels 411 of wheeled vehicle 410 and rotates due to friction with wheels 411 of wheeled vehicle 410. In this manner, a driver of wheeled vehicle 410 accelerates wheels 411 of wheeled vehicle 410, and wheels 411 in turn rotate rolling elements 420.

Rolling elements 420 may be arranged to be moved by a single wheel, by two wheels or by more wheels. Rolling elements 420 may be coupled with either front or rear wheels, relating to the type of drive (front-wheel drive or rear-wheel drive) of wheeled vehicle 410. Rolling elements 420 may be arranged to allow moving an axis of wheel 411 of wheeled vehicle 410 while in contact with rolling elements 420. Rolling elements 420 may be arranged to be movable upon moving the axis of wheels of wheeled vehicle 410, e.g., rolling elements 420 may be mounted on a bearing 460 that may rotate rolling elements 420 with wheels 411. Bearing 460 may be arranged to allow moving the rotation axis of rolling elements 420, e.g., according to steering movement of wheels 411 of wheeled vehicle 410. As a result, directing vehicle 400 may be carried out by directing wheeled vehicle 410 and transmitting the direction commands via wheels 411 and rolling elements 420 to vehicle 400, e.g., to the propulsion means or to a rudder 470. Rudder 470 may be arranged to allow steering of vehicle 400 in relation to steering of wheeled vehicle 410.

Vehicle 400 may further comprise a propulsion screw 450. Rolling elements 420 may be connected to propulsion screw 450 via a mechanical transmitter arranged to deliver rotational forces from rolling elements 420 to propulsion screw 450 (e.g., an Archimedes screw). Propulsion screw 450 may be arranged to move vehicle 400 with integrated wheeled vehicle through fluids such as water or through sand, as well as through interchanging fluid and sandy medias.

Vehicle 400 may comprise wheels 421 for enabling towing of vehicle 400 by a wheeled vehicle. Vehicle 400 may further comprise a vehicle connector (not shown in FIG. 5), such that vehicle 400 may be towed by another vehicle, or by wheeled vehicle 410 itself.

According to some embodiments of the invention, vehicle 400 comprises a mechanical transmitter comprising belts 425, shafts, gear boxes 431, and additional mechanical elements arranged to deliver the rotational forces from rolling elements 420 to propulsion screw 450.

According to some embodiments of the invention, propulsion screw 450 may be partly or fully covered with a configurable shield 451. Configurable shield 451 may be arranged to be configurable depending on environmental conditions and medium in which vehicle 400 moves. Configurable shield may be arranged to enhance the functioning of propulsion screw 450. For example, configurable shield 451 may be closed to produced necessary pressure for moving in fluid, and partly open for moving in sand.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. In a vehicle comprising a wheeled vehicle and propulsion means, wherein the wheeled vehicle comprises wheels, a device for transmitting a propelling force of the wheeled vehicle to the propulsion means, the device comprising:
a frame arranged to support the wheeled vehicle and to enable the integration of the wheeled vehicle within the vehicle;
at least one rolling element operatively in contact with at least one wheel of the wheeled vehicle and arranged to rotate due to friction with the at least one wheel of the wheeled vehicle; and
a mechanical transmitter arranged to deliver rotational forces from the at least one rolling element to the propulsion means of the vehicle.

2. The device of claim 1, wherein the mechanical transmitter comprises at least one of: a belt, a gear box, and differentials.

3 The device of claim 1, wherein the at least one rolling element comprises a surface characterized by a high friction coefficient with respect the wheels of the wheeled vehicle and is arranged to be moved upon rotation of the at least one wheel, and at least one other component arranged to operatively transmit the movement of the surface to the mechanical transmitter.

4. The device of claim 1, wherein each driving wheel of the wheels of the wheeled vehicle is in contact with at least one rolling element.

5. The device of claim 1, wherein the at least one rolling element is further arranged to allow moving an axis of the at least one wheel while keeping contact with the at least one rolling element.

6. A vehicle propelled by a propelling force of a wheeled vehicle integrated within the vehicle, comprising:
propulsion means;
a frame arranged to support the wheeled vehicle and to enable the integration of the wheeled vehicle within the vehicle;
at least one rolling element operatively in contact with the wheels of the wheeled vehicle and arranged to rotate due to friction with the wheels of the wheeled vehicle; and
a mechanical transmitter arranged to deliver rotational forces from the at least one rolling element to the propulsion means of the vehicle.

7. The vehicle of claim 6, wherein the vehicle is a marine vehicle and further comprises floaters, and wherein the propulsion means is arranged to move the vehicle through a fluid.

8. The vehicle of claim 6, further comprising wheels and a vehicle connector, wherein vehicle is arranged to be towable by the wheeled vehicle.

9. The vehicle of claim 6, wherein the propulsion means comprises at least one propeller.

10. The vehicle of claim 6, wherein the propulsion means comprises at least one propulsion screw.

11. The vehicle of claim 10, further comprising at least one configurable shield arranged to enhance the functioning of the at least one propulsion screw.

12. The vehicle of claim 6, wherein the mechanical transmitter comprises at least one of: a belt, a gear box, and differentials.

13. The vehicle of claim 6, wherein the at least one rolling element comprises a surface characterized by a high friction coefficient in respect the wheels of the wheeled vehicle and arranged to be moved upon rotation of the wheels, and at least one other component arranged to operatively transmit the movement of the surface to the mechanical transmitter.

14. The vehicle of claim 6, wherein each driving wheel of the wheels of the wheeled vehicle is in contact with at least one rolling element.

15. The vehicle of claim 6, wherein the at least one rolling element is further arranged to allow moving the axis of the at least one wheel while keeping contact with the at least one rolling element.

16. The vehicle of claim 15, wherein the at least one rolling element is characterized by a rotation axis and wherein the at least one rolling element is mounted on a bearing arranged to allow moving of the rotation axis of the at least one rolling element.

17. The vehicle of claim 6, further comprising at least one rudder arranged to allow steering of the vehicle in relation to steering of the wheeled vehicle.

18. The vehicle of claim 6, further comprising a docking system arranged to allow connecting the vehicle to other vehicles.

19. The vehicle of claim 18, wherein the docking system is arranged to allow connecting the vehicle serially to other vehicles.

20. A marine vehicle propelled by a propelling force of a wheeled vehicle integrated within the marine vehicle, the marine vehicle comprising:
a boat arranged to support the wheeled vehicle;
at least one propeller arranged to operationally propel the boat;
at least one rolling element connected to the boat and arranged to support at least one wheel of the wheeled vehicle,
a mechanical transmitter comprising at least one belt, a first shaft, a gear box, a second shaft, differentials and an axle,
wherein the at least one rolling element operationally utilizes high frictional forces with the at least one wheel to receive the rotation of the at least one wheel,
wherein the first shaft is connected via the at least one belt to the at least one rolling element such as to transmit rotation of the at least one rolling to the first shaft,
wherein the gear box is connected to the second shaft and arranged to transmit rotation of the first shaft to the second shaft according to a predefined gear position,
wherein the differentials are connected to the second shaft and arranged to transmit rotation of the second shaft to the axle, and
wherein the axle is connected to the at least one propeller and arranged to transmit rotation to the at least one propeller.

21. The marine vehicle of claim 20, further comprising a docking system arranged to allow connecting the marine vehicle to other vehicles.

22. The marine vehicle of claim 21, wherein the docking system is arranged to allow connecting the marine vehicle serially to other vehicles.
